(19) United States
(12) Patent Application Publication
(10) Pub. No.: US 2024/0427142 A1
(43) Pub. Date: Dec. 26, 2024

(54) EXTENDED REALITY GLASS DEVICE AND DISPLAY APPARATUS THEREOF

(71) Applicant: ELECTRONICS AND TELECOMMUNICATIONS RESEARCH INSTITUTE, Daejeon (KR)

(72) Inventors: Min-Sung YOON, Daejeon (KR); Hyoung LEE, Daejeon (KR)

(73) Assignee: ELECTRONICS AND TELECOMMUNICATIONS RESEARCH INSTITUTE, Daejeon (KR)

(21) Appl. No.: 18/749,139

(22) Filed: Jun. 20, 2024

(30) Foreign Application Priority Data
Jun. 21, 2023 (KR) 10-2023-0079569
May 22, 2024 (KR) 10-2024-0066449

(51) Int. Cl. G02B 27/00; G02B 3/00; G02B 6/42; G02B 27/01; G06F 1/16

(52) U.S. Cl. CPC G02B 27/0025; G02B 3/0037; G02B 27/0172; G06F 1/163; G02B 6/4206; G02B 2027/0112; G02B 2027/0174

(57) ABSTRACT

Disclosed herein is an extended Reality (XR) glass device. The XR glass device may include a display unit, an optical waveguide, an in-coupler for in-coupling an image output from the display unit to the optical waveguide, and an out-coupler for out-coupling the image propagated along the optical waveguide to an eye, and the display unit may include a Micro Lens Array (MLA) in which respective micro lenses spatially correspond to multiple red (R) light sources, green (G) light sources, and blue (B) light sources.

### CROSS REFERENCE TO RELATED APPLICATIONS

This application claims the benefit of Korean Patent Applications No. 10-2023-0079569, filed Jun. 21, 2023, and No. 10-2024-0066449, filed May 22, 2024, which are hereby incorporated by reference in their entireties into this application.

### BACKGROUND OF THE INVENTION

### 1. Technical Field

The disclosed embodiment relates to glass device technology used for extended Reality (XR).

### 2. Description of the Related Art

extended Reality (XR) technology refers to technology that encompasses Virtual Reality (VR), Augmented Reality (AR), and Mixed Reality (MR) technologies. The XR technology utilizes smart-glass-based ultra-high-resolution display devices that can be applied to the fusion of virtual or real worlds, metaverse experiences, and the like by enabling users to be immersed in hyper-realistic video or 3D content with the highest quality.

Recently, with the gradual advancement in existing VR/AR display technology, Samsung Electronics (HMD Odyssey) and other global IT companies, such as Microsoft (HoloLens 2), Meta (Quest 3), Apple (Vision Pro), etc., have released display devices in the form of face-worn MR/XR glasses (headsets) based on a device equipped with a high-resolution panel to suit the needs of users, and these display devices address the discomfort that is caused when viewing metaverse content or ultra-realistic video content or when wearing the device. Also, the annual global market size for these headset devices related to smart glasses is steadily increasing.

The main components of such XR devices include micro display panels, optical elements and sensors, memory and system semiconductors, optical parts, communication devices and batteries, software, and the like. Particularly, the recent micro display panels for XR glasses apply 4K or higher resolution in order to display ultra-realistic image information. Also, high-speed playback technology capable of image input at a refresh rate of 120 Hz or higher is required.

Particularly, it is required to use various optical components, which are available thanks to the advancement in optical design technology, to thereby solve image quality problems, including image distortion, chromatic aberration, and parallax, and a dizziness problem, which results from application of geometrical characteristics for improving a field of view and a vergence-accommodation mismatch, and to use functional optical components capable of enhancing user convenience, such as technology for designing a slim optical system for the miniaturization of form factors, and the like.

Meanwhile, types of XR devices can be broadly classified into VR/MR headsets, AR headsets, and AR smart glasses.

First, the VR/MR headsets are evolving from typical VR products to camera see-through MR products. The existing typical VR products have limitations in projecting virtual information onto reality to substitute for the reality, because displays used therein, such as a thin-film-transistor liquid-crystal display (TFT-LCD), an organic light-emitting diode (OLED), and the like, have low pixel density. Also, a wide Field of View (FoV) is required.

The AR headsets are AR-based products in the form of headset devices such as goggles/helmets, and augmented reality technology is being applied in industrial fields, such as manufacturing, distribution, healthcare, and the like, under the name of industrial augmented reality. Unlike general augmented reality devices, industrial augmented reality devices are products of which characteristics and functionalities are considered important, and require high-resolution displays. Because they are products based on AR, it is likely that they employ Liquid Crystal on Silicon (LCoS), which is suitable for high brightness.

The AR smart glasses are products for which displays gradually changing from low-resolution (HD) to high-resolution (FHD) are being released, and some products are text-based monochrome products. Although ever-higher resolution displays are being developed, the necessities for multi-information and video content are increasing, so it is essential to increase resolution. As products requiring the optimization of information, video, sizes, weights, etc., 0.3 inches or smaller products are required for the displays in consideration of the minimization of an optical system size. Here, the optimal resolution for this screen size is expected to be FHD, and the demand for development of such products is increasing in the actual market.

Currently, the AR/VR smart glasses employ optical methods, such as a Birdbath type, an Exit Pupil Expander (EPE) type, and a PinTILT type.

The Birdbath type has the advantages of a simple optical structure, strong durability, and high manufacturability, but it requires additional optical systems for form factors and has the disadvantages of low light efficiency and low transmittance of 50% to 12%. Also, the low transmittance makes eye contact difficult. Accordingly, a problem in which glasses are too thick or heavy to wear for long hours is caused, and it is necessary to solve this problem.

The EPE type is AR/VR glasses typically using optical waveguides, and it is designed to be thinner and more similar to eyeglasses. The EPE type has the advantage of a wide field of view, but the complex structure thereof causes image quality degradation and low durability and manufacturability. Particularly, the EPE type has the disadvantage of high power consumption due to low light efficiency ranging from 0.5% to 0.05% and requires additional engine optics.

The PinTILT type remedies and compensates for the disadvantages of the above-described Birdbath and EPE types by utilizing pin mirrors and the PinTILT principle, so it has a simple structure, strong durability, and high manufacturability. Also, it does not require additional form factors because it uses an embedded collimator, and has light efficiency ranging from 50% to 12% and high transmittance ranging from 90% to 70%. However, it is necessary to solve the problems of visibility of the collimator and the pin mirrors within the glasses.

In these XR devices for smart glasses, light efficiency is crucial for reducing the weight and volume of the system as well as for providing high-quality images. However, the above-mentioned types of existing AR/VR smart glasses have low light efficiency in the process in which a great portion of light that should be incident to the eyes through an optical waveguide is transferred to the eye box.

Particularly, among the methods used for AR/VR smart glasses, the Exit Pupil Expander (EPE) type is most commonly used. However, the low light efficiency problem caused due to the use of an optical waveguide not only degrades the quality of viewed images but also requires more power consumption in order to compensate for the low quality. Further, in order to address these problems, additional optical components such as lenses have been inserted, which results in an increase in the size and weight of the AR/VR smart glasses.

### SUMMARY OF THE INVENTION

An object of the disclosed embodiment is to combine a micro-OLED-type image display terminal, a Micro Lens Array (MLA), and optical devices in order to maximize light efficiency.

Another object of the disclosed embodiment is to improve the optical efficiency of an extended Reality (XR) glass device, thereby reducing energy consumption and the thickness and weight of the XR glass device.

An extended Reality (XR) glass device according to an embodiment includes a display unit, an optical waveguide, an in-coupler for in-coupling an image output from the display unit to the optical waveguide, and an out-coupler for out-coupling the image propagated along the optical waveguide to an eye. The display unit may include a Micro Lens Array (MLA) in which respective micro lenses spatially correspond to multiple red (R) light sources, green (G) light sources, and blue (B) light sources.

Here, curvature and surface characteristics of the lens of the micro lens array may be designed based on chromatic aberration corresponding to a central wavelength of each of the multiple red (R) light sources, green (G) light sources, and blue (B) light sources.

Here, each of the lenses of the micro lens array may have one of a square shape, a rectangular shape, a circular shape, and an elliptical shape.

Here, the display unit may include a panel configured with multiple red (R) light sources, green (G) light sources, and blue (B) light sources and from which an image is output, a Micro Lens Array (MLA) in which respective micro lenses spatially correspond to the multiple red (R) light sources, green (G) light sources, and blue (B) light sources, and a cover layer between the panel and the micro lens array, the cover layer having the same refractive index as the substrate of the micro lens array.

Here, the cover layer may be formed of one of fused silica, BK7, and S-TIH53.

Here, a separation distance between the panel and the micro lens array may be equal to the focal length (f) of the lens of the micro lens array.

Here, the display unit may further include a Holographic Optical Element (HOE) on the top of the micro lens array.

Here, the display unit may be disposed to be rotated such that an incidence angle of light incident to the optical waveguide becomes an acute angle.

Here, the pitch of each of the micro lenses of the micro lens array may correspond to each of the light sources of the panel in a one-to-one manner.

Here, in the panel, the red (R) light sources, the green (G) light sources, and the blue (B) light sources may be arranged in respective straight lines.

Here, in the panel, the red (R) light sources, the green (G) light sources, and the blue (B) light sources may be arranged in respective diagonal lines.

Here, in the panel, the red (R) light sources, the green (G) light sources, and the blue (B) light sources may be arranged in triangular forms.

Here, the pitch of each of the micro lenses of the micro lens array may correspond to each of the light sources of the panel in a ratio of 1:3N (N being a positive integer).

A display apparatus configured to output an image towards an optical waveguide of an extended Reality (XR) glass device according to an embodiment may include a panel configured with multiple red (R) light sources, green (G) light sources, and blue (B) light sources and from which an image is output; and a Micro Lens Array (MLA) in which respective micro lenses spatially correspond to the multiple red (R) light sources, green (G) light sources, and blue (B) light sources.

Here, curvature and surface characteristics of the lens of the micro lens array may be designed based on chromatic aberration corresponding to a central wavelength of each of the multiple red (R) light sources, green (G) light sources, and blue (B) light sources.

Here, the display apparatus may include a cover layer between the panel and the micro lens array, the cover layer having the same refractive index as the substrate of the micro lens array.

Here, the display apparatus may further include a Holographic Optical Element (HOE) on the top of the micro lens array.

Here, the display apparatus may be disposed to be rotated such that an incidence angle of light incident to the optical waveguide becomes an acute angle.

Here, the pitch of each of the micro lenses of the micro lens array may correspond to each of the light sources of the panel in a one-to-one manner.

Here, the pitch of each of the micro lenses of the micro lens array may correspond to each of the light sources of the panel in a ratio of 1:3N (N being a positive integer).

### BRIEF DESCRIPTION OF THE DRAWINGS

The above and other objects, features, and advantages of the present disclosure will be more clearly understood from the following detailed description taken in conjunction with the accompanying drawings, in which:

FIGS. 1 to 3 are exemplary views of a schematic configuration of an extended Reality (XR) glass device to which an embodiment is applied;

FIG. 4 is a side view of a micro lens array;

FIGS. 5 and 6 are exemplary views of the shape of a surface of a micro lens array;

FIGS. 7 and 8 are side views of a display unit of an XR glass device according to an embodiment;

FIG. 9 is an exemplary view for explaining a light-collecting effect of a micro lens array;

FIG. 10 is an exemplary view of pixel arrangement according to an embodiment;

FIG. 11 is a side view of a display unit of an XR glass device according to an embodiment;

FIG. 12 is an exemplary view of the direction of light in a display unit of an XR glass device according to an embodiment;

FIG. 13 is an exemplary view of disposition of a display unit according to an embodiment;

FIG. 14 is a side view of a display unit according to another embodiment;

FIG. 15 is an exemplary view of disposition of a display unit according to another embodiment; and

FIGS. 16 to 18 are various embodiments of the pitch of a micro lens.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

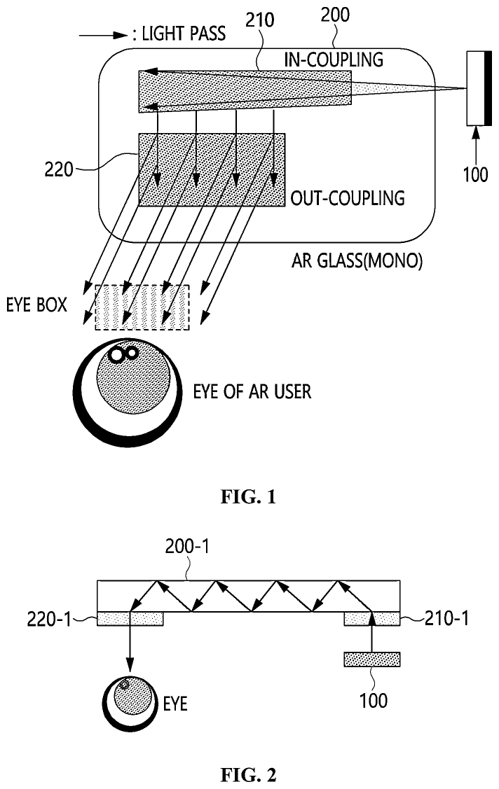

FIGS. 1 to 3 are exemplary views of a schematic configuration of an extended Reality (XR) glass device to which an embodiment is applied.

Referring to FIG. 1, the XR glass device to which an embodiment is applied may be a commercialized Exit Pupil Expander (EPE) type of XR glass device.

The XR glass device may include a display unit 100, an optical waveguide 200, an in-coupler 210 for in-coupling an image output from the display unit 100 to the optical waveguide 200, and an out-coupler 220 for out-coupling the image propagated along the optical waveguide to an eye.

FIG. 2 shows an XR glass device from which monochromatic light is emitted and a single-layer single optical waveguide 200-1 configured to propagate the image output from the display unit 100, and an in-coupler 210-1 and an out-coupler 220-1 are attached to the single optical waveguide 200-1.

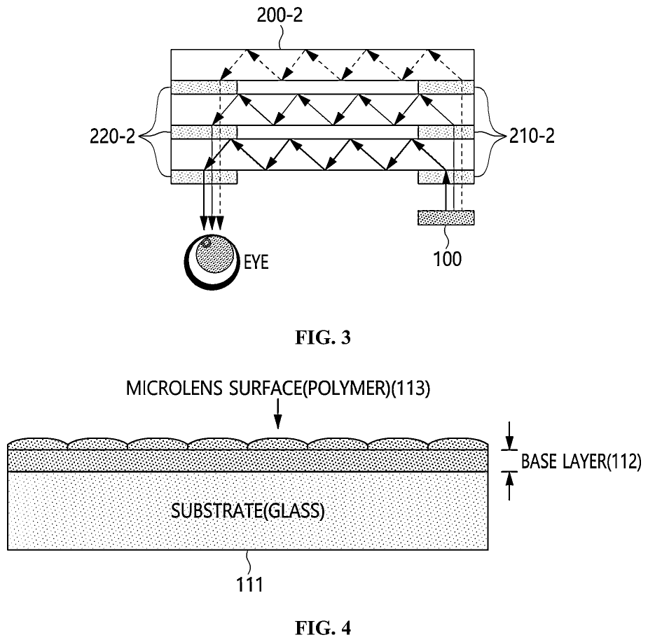

FIG. 3 shows an XR glass device from which light of three primary RGB colors is emitted and layered multiple optical waveguides 200-2 that are configured to respectively propagate RGB colors in the image output from the display unit 100, and in-couplers 210-2 and out-couplers 220-2 are attached to the corresponding ones of the layered optical waveguides 200-1.

In the XR glass device configured as described above, an image (a light wave) output from the display unit 100 based on a micro OLED panel reaches the eye of a user via the optical waveguide 200.

However, in the case of the final out-coupled light emitted towards an eyebox region via a complex light path, a large amount of light loss is caused, compared to the amount of incident light. Also, a large amount of light loss is caused in the in-coupler 210 through which the light emitted from the display unit 100 is injected to the optical waveguide 200.

Due to such a characteristic of the optical waveguide 200, the quality of the image viewed from the position of the eyebox, at which the eye of a user is located, is degraded, and power consumption increases due to low light efficiency.

In order to overcome these problems, the disclosed embodiment proposes an approach for designing and arranging a Micro Lens Array (MLA) having light-focusing and light-collecting functions so as to correspond to the spatial arrangement of Red (R), Green (G), and Blue (B) pixels, which are light sources within the micro OLED panel of the display unit 100.

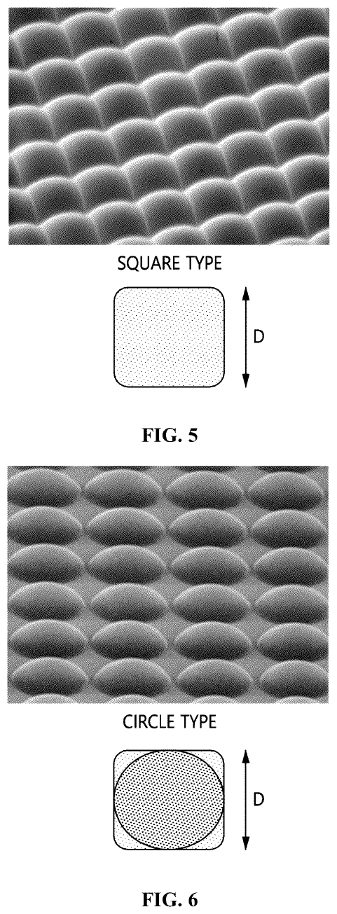

FIG. 4 is a side view of a micro lens array, and FIGS. 5 and 6 are exemplary views of the shape of a surface of a micro lens array.

Referring to FIG. 4, the micro lens array 110 is in the form of convex lenses and has a form in which small lenses, each having a micrometer-level diameter, are arranged in a two-dimensional (2D) plane.

Specifically, the micro lens array 110 may be configured with a substrate 111, a base layer 112, and a microlens surface 113.

Also, the micro lens array 110 is disposed in parallel to the surface of the panel 120 by using thin-film-type lenses as the material thereof, whereby an ultra-slim and ultra lightweight display unit 100 may be implemented.

In the micro lens array 110, each of the lenses may be formed in one of various shapes, including a square, a rectangle, a circle, and an ellipse, as illustrated in FIG. 5 and FIG. 6.

Meanwhile, in order to increase the efficiency of light passing through the micro lens array 110, each of the lenses of the micro lens array 110 is designed such that the curvature and surface characteristics of the lens are differentiated by taking into account aberration (or chromatic aberration) to thereby making the lens correspond to the central wavelength of the light source (R/G/B) in a one-to-one manner.

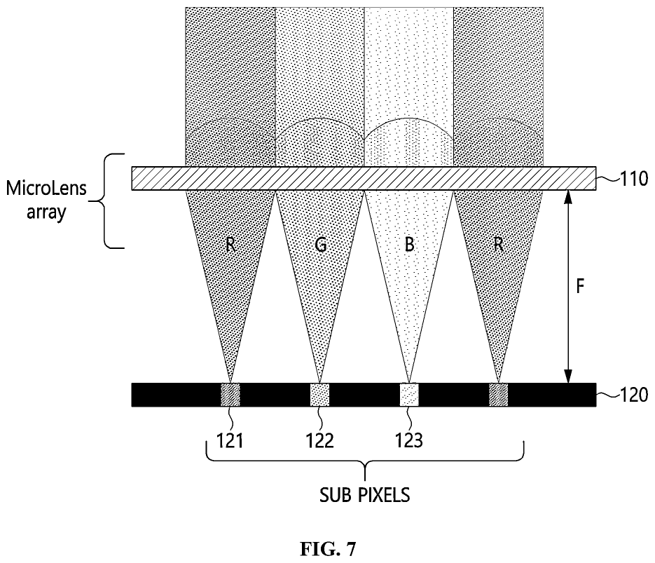

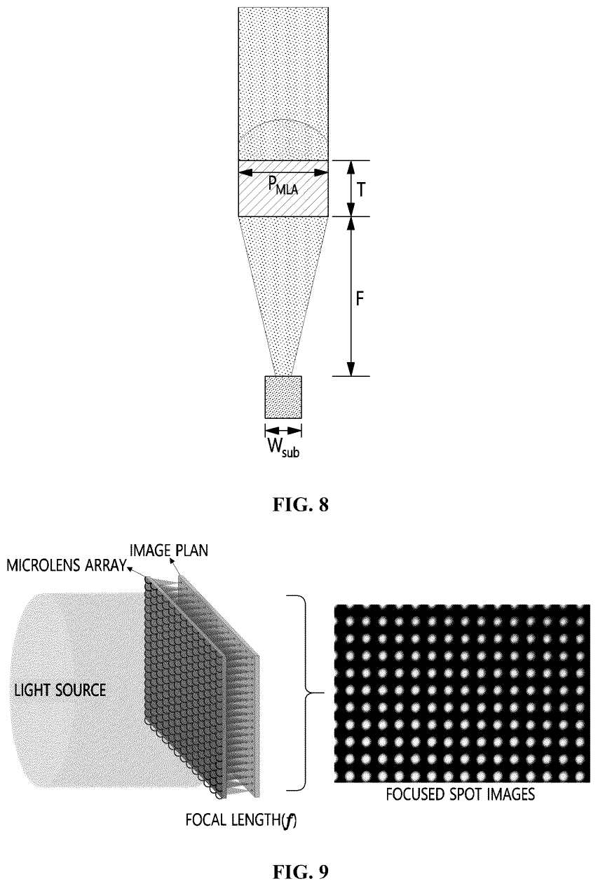

FIG. 7 and FIG. 8 are side views of a display unit of an XR glass device according to an embodiment.

Referring to FIG. 7, the display unit 100 according to an embodiment includes a panel 120, configured with multiple red (R) light sources 121, green (G) light sources 122, and blue (B) light sources 123 and from which an image is output, and a Micro Lens Array (MLA) 110 in which each of micro lenses spatially corresponds to each of the multiple red (R) light sources 121, green (G) light sources 122, and blue (B) light sources 123 of the panel 120.

According to an embodiment, the separation distance between the panel 120 and the micro lens array 110 may be approximately represented as F.

Here, the separation distance ranges from several to tens of micrometers (μm), and it is determined depending on the characteristics of the micro lens array 110.

Referring to FIG. 8, light emitted from a subpixel light source having a width of Wsub (several micrometers) is focused and collected by each of the lenses of the micro lens array, which has the pitch of P_{MLA}.

As described above, arrangement is made such that the center of a micro lens and the center of a light source correspond to each other in a one-to-one manner according to accurate arrangement criteria by considering chromatic aberration for an individual pixel, whereby light output from the panel 120 may be output towards the optical waveguide 200 as parallel straight light without aberration after passing through the micro lens array 110. Forming the parallel straight light using the micro lens array 110 will be described below with reference to FIG. 9.

FIG. 9 is an exemplary view for explaining a light-collecting effect of a micro lens array.

Referring to FIG. 9, it can be seen that parallel straight light emitted to the top of a micro lens array passes through the micro lens array and is then collected as point light sources and focused in the form of a 2D array in an output surface, which is located a predetermined focal length (f) apart from the surface of the micro lens array.

Accordingly, when the principle of time-reversal of light is applied based on this phenomenon, passing the light emitted from the red (R) light source 121, the green (G) light source 122, and the blue (B) light source 123 of the panel 120, that is, the light emitted from the R/G/B pixels of the panel 120, through the micro lens array 110 reversely results in output of parallel straight light, as illustrated in FIG. 7, whereby the effect of light having parallel straightness (light focusing and collecting effects) may be obtained.

That is, because parallel straight light obtained by passing through the micro lens array 110 may be maximally injected when it is in-coupled to the in-coupler 210 of the optical waveguide 200, the maximum light efficiency may be obtained.

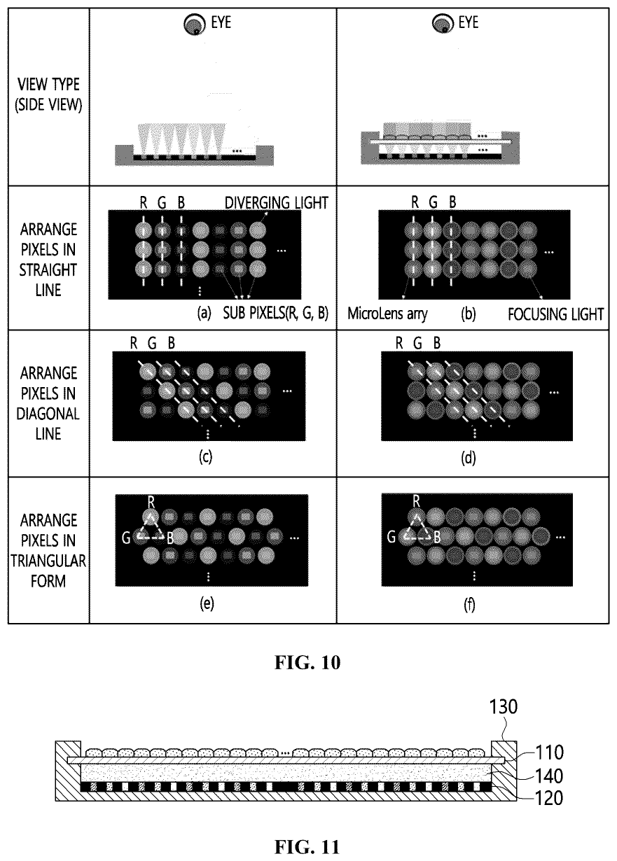

FIG. 10 is an exemplary view of pixel arrangement of a display unit according to an embodiment.

As illustrated in FIG. 10, the arrangement of red (R) light sources, green (G) light sources, and blue (B) light sources in a panel may have various embodiments.

According to an embodiment, in the panel, the red (R) light sources, the green (G) light sources, and the blue (B) light sources may be arranged in respective straight lines, as illustrated in (a).

Accordingly, the micro lens array may be configured such that lenses having curvature and surface characteristics in which aberration corresponding to the central wavelength of each of the red (R) light sources arranged in the straight line is taken into account are arranged in a straight line, lenses having curvature and surface characteristics in which aberration corresponding to the central wavelength of each of the green (G) light sources arranged in the straight line is taken into account are arranged in a straight line, and lenses having curvature and surface characteristics in which aberration corresponding to the central wavelength of each of the blue (B) light sources arranged in the straight line is taken into account are arranged in a straight line, as illustrated in (b).

According to another embodiment, in the panel, the red (R) light sources, the green (G) light sources, and the blue (B) light sources may be arranged in respective diagonal lines, as illustrated in (c).

Accordingly, the micro lens array may be configured such that lenses having curvature and surface characteristics in which aberration corresponding to the central wavelength of each of the red (R) light sources arranged in the diagonal line is taken into account are arranged in a diagonal line, lenses having curvature and surface characteristics in which aberration corresponding to the central wavelength of each of the green (G) light sources arranged in the diagonal line is taken into account are arranged in a diagonal line, and lenses having curvature and surface characteristics in which aberration corresponding to the central wavelength of each of the blue (B) light sources arranged in the diagonal line is taken into account are arranged in a diagonal line, as illustrated in (d).

According to a further embodiment, in the panel, the red (R) light source, the green (G) light source, and the blue (B) light source may be arranged to form a triangle, as illustrated in (e).

Accordingly, the micro lens array may be configured such that lenses having curvature and surface characteristics in which aberration corresponding to the central wavelengths of the respective light sources is taken into account are arranged at the locations corresponding to the red (R) light source, the green (G) light source, and the blue (B) light source arranged in the triangular form so as to form a triangular shape, as illustrated in (f).

However, the arrangements illustrated in FIG. 10 are merely embodiments of the present disclosure, and the present disclosure is not limited thereto. Therefore, other embodiments for the arrangement are also possible depending on the manufacturing environment, the type of a display image, and the like.

FIG. 11 is an exemplary view of a side surface of a display unit of an XR glass device according to an embodiment.

Referring to FIG. 11, the display unit 100 according to an embodiment may further include a cover layer 140 in the empty space between the panel 120 and the micro lens array 110, and the cover layer 140 has the same refractive index as the substrate of the micro lens array 110.

Here, the cover array 140 may be formed of one of materials including fused silica, BK7, and S-TIH53.

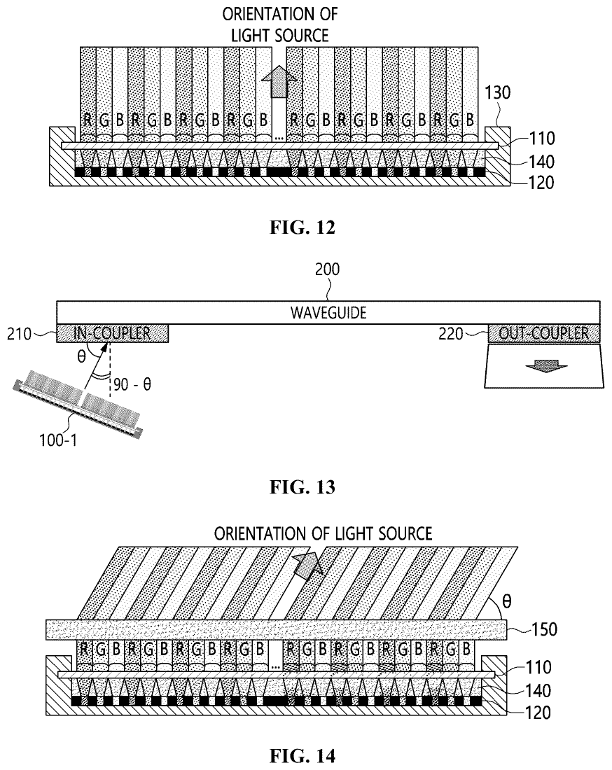

FIG. 12 is an exemplary view of the direction of light in the display unit of an XR glass device according to an embodiment.

Referring to FIG. 12, when the micro lens array 110 and the panel 120 are disposed to be parallel to each other, passing the light output from the panel 120 through the micro lens array 110 imparts parallel straightness to the light, whereby the light is in-coupled to the optical waveguide 200 of the XR glass device.

Meanwhile, in an embodiment, the parallel straight light emitted in the direction perpendicular to the surface of the micro lens array 110 after passing through the surface of the micro lens array 110 may be deflected to make a desired angle (e) so as to be uniformly directed in one direction.

To this end, according to an embodiment, the display unit 100-1 may be disposed to be rotated such that the incidence angle of light incident to the optical waveguide 200 becomes an acute angle.

FIG. 13 is an exemplary view of the disposition of a display unit according to an embodiment.

Referring to FIG. 13, the display unit 100-1 may be disposed to be rotated by (90-0) degrees relative to the in-coupler 210 in order to design the incident light emitted from the display unit 100-1 to the in-coupler 210 of the optical waveguide 200 to make a predetermined angle (e).

According to another embodiment, the display unit 100-2 may further include a Holographic Optical Element (HOE) on the top of the micro lens array.

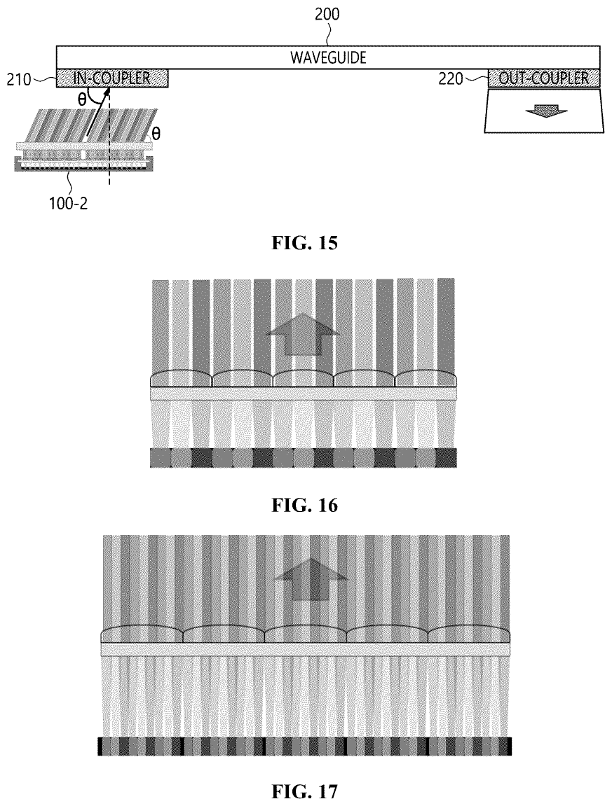

FIG. 14 is a side view of a display unit according to another embodiment, and FIG. 15 is an exemplary view of the disposition of a display unit according to another embodiment.

Referring to FIG. 14, the display unit 100-2 according to another embodiment is configured such that the holographic optical element (HOE) 150 functioning as a uniform beam deflector is disposed on the top of the micro lens array 110 to be parallel to the micro lens array 110.

Here, the holographic optical element 150 is an optically transparent medium, and is a transmissive HOE.

Referring to FIG. 14, the holographic optical element (HOE) 150 may be designed such that an incident angle is perpendicular to the surface of the HOE 150 (0 degrees), and the exit angle of the HOE 150 may be set to (90-θ) degrees such that the angle at which light is incident to the in-coupler 210 becomes θ degrees.

Accordingly, the display unit 100-2 may be fixedly disposed without the need to rotate by a predetermined angle varying depending on the location relative to the optical waveguide 200. That is, referring to FIG. 15, the display unit 100-2 may be disposed to be parallel to the in-coupler 210.

In this case, the display unit 100-2 can be disposed as much closer as possible to the surface of the in-coupler 210, whereby the spatial disposition or arrangement between optical components may be facilitated and the entire volume of the display unit 100-2 may be minimized (or optimized).

Meanwhile, the pitch of each of the micro lenses in the micro lens array may correspond to each of the light sources of the panel in a ratio of 1:3N (N being a positive integer).

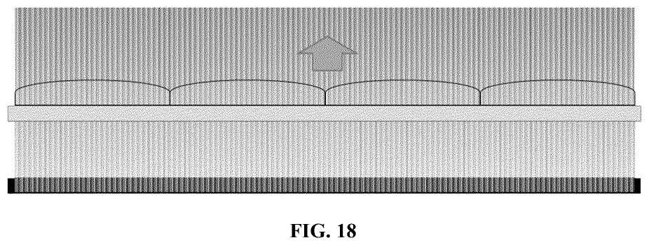

FIGS. 16 to 18 are various embodiments of the pitch of a micro lens.

That is, the method of bundling pixels may vary depending on the condition of the pitch P_{MLA} of each lens in a micro lens array, as illustrated in FIGS. 16 to 18.

FIGS. 16 to 18 illustrate embodiments for geometrical arrangement and bundles through which the ratios of pixels of a micro OLED panel to the pitch P_{MLA} of each lens of the micro lens array respectively correspond to 3:1, 9:1, and 30:1.

The method of bundling pixels and the arrangement of a micro lens array that are configured to have such a flexible ratio facilitate the production of an XR glass device.

In the XR glass device according to the above-described embodiment, energy may be effectively reduced by maximizing light efficiency, and the volume and weight of a module may be reduced by reducing the thickness thereof.

According to the disclosed embodiment, existing bulky optical lenses for light collection and optical components for alignment are removed, and a thin-film-type Micro Lens Array (MLA) is used to substitute therefor, whereby an extended Reality (XR) glass device that a user can comfortably and safely wear may be implemented.

According to the disclosed embodiment, the light efficiency of an XR glass device is maximized, whereby the energy consumed by the XR glass device may be effectively reduced.

According to the disclosed embodiment, in order to increase the transmittance of incident light, the gap between the surface layer of an R/G/B light source unit within a micro OLED and a Micro Lens Array (MLA) is covered to have a refractive index equal or similar to the refractive index of the substrate of the MLA, whereby the amount of light reflected from the surface of the MLA after incidence thereto may be minimized and the amount of light passing through the MLA may be maximized. Also, 1:1 lens design is applied such that a shape of each lens of the MLA corresponds to each R/G/B wavelength in a light source unit pixel, whereby high light-focusing and light-collecting effects may be obtained.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An extended Reality (XR) glass device, comprising:
a display unit;
an optical waveguide;
an in-coupler for in-coupling an image output from the display unit to the optical waveguide; and
an out-coupler for out-coupling the image propagated along the optical waveguide to an eye,
wherein:
the display unit includes a Micro Lens Array (MLA) in which respective micro lenses spatially correspond to multiple red (R) light sources, green (G) light sources, and blue (B) light sources.

2. The XR glass device of claim 1, wherein curvature and surface characteristics of the lens of the micro lens array are designed based on chromatic aberration corresponding to a central wavelength of each of the multiple red (R) light sources, green (G) light sources, and blue (B) light sources.

3. The XR glass device of claim 1, wherein each of the lenses of the micro lens array has one of a square shape, a rectangular shape, a circular shape, and an elliptical shape.

4. The XR glass device of claim 1, wherein the display unit further includes
a panel configured with multiple red (R) light sources, green (G) light sources, and blue (B) light sources and from which an image is output; and
a cover layer between the panel and the micro lens array, the cover layer having a same refractive index as a substrate of the micro lens array.

5. The XR glass device of claim 4, wherein the cover layer is formed of one of fused silica, BK7, and S-TIH53.

6. The XR glass device of claim 4, wherein a separation distance between the panel and the micro lens array is equal to a focal length (f) of the lens of the micro lens array.

7. The XR glass device of claim 1, wherein the display unit further includes a Holographic Optical Element (HOE) on a top of the micro lens array.

8. The XR glass device of claim 1, wherein the display unit is disposed to be rotated such that an incidence angle of light incident to the optical waveguide becomes an acute angle.

9. The XR glass device of claim 1, wherein a pitch of each of the micro lenses of the micro lens array corresponds to each of light sources of a panel in a one-to-one manner.

10. The XR glass device of claim 9, wherein, in the panel, the red (R) light sources, the green (G) light sources, and the blue (B) light sources are arranged in respective straight lines.

11. The XR glass device of claim 9, wherein, in the panel, the red (R) light sources, the green (G) light sources, and the blue (B) light sources are arranged in respective diagonal lines.

12. The XR glass device of claim 9, wherein, in the panel, the red (R) light sources, the green (G) light sources, and the blue (B) light sources are arranged in triangular forms.

13. The XR glass device of claim 1, wherein a pitch of each of the micro lenses of the micro lens array corresponds to each of light sources of a panel in a ratio of 1:3N (N being a positive integer).

14. A display apparatus of an extended Reality (XR) glass device, configured to output an image towards an optical waveguide of the XR glass device,
the display apparatus comprising:
a panel configured with multiple red (R) light sources, green (G) light sources, and blue (B) light sources and from which an image is output; and
a Micro Lens Array (MLA) in which respective micro lenses spatially correspond to the multiple red (R) light sources, green (G) light sources, and blue (B) light sources.

15. The display apparatus of claim 14, wherein curvature and surface characteristics of the lens of the micro lens array are designed based on chromatic aberration corresponding to a central wavelength of each of the multiple red (R) light sources, green (G) light sources, and blue (B) light sources.

16. The display apparatus of claim 14, further comprising:
a cover layer between the panel and the micro lens array, the cover layer having a same refractive index as a substrate of the micro lens array.

17. The display apparatus of claim 14, further comprising:
a Holographic Optical Element (HOE) on a top of the micro lens array.

18. The display apparatus of claim 14, wherein the display apparatus is disposed to be rotated such that an incidence angle of light incident to the optical waveguide becomes an acute angle.

19. The display apparatus of claim 14, wherein a pitch of each of the micro lenses of the micro lens array corresponds to each of the light sources of the panel in a one-to-one manner.

20. The display apparatus of claim 14, wherein a pitch of each of the micro lenses of the micro lens array corresponds to each of the light sources of the panel in a ratio of 1:3N (N being a positive integer).
